(19) United States
(12) Patent Application Publication
(10) Pub. No.: US 2009/0193866 A1
(43) Pub. Date: Aug. 6, 2009

(54) Minimizing circumferential transition lines during container shaping operations

(76) Inventor: Peter Hamstra, Kingston (CA)

Correspondence Address: Christopher C. Dunham;c/o Cooper & Dunham LLP, 30 Rockefeller Plaza, New York, NY, 10112, US

(21) Appl. No.: 12/322,092

(22) Filed: Jan. 28, 2009

Related U.S. Application Data
(60) Provisional application No. 61/063,187, filed on Feb. 1, 2008.

(51) Int. Cl. B21D 19/00; B21K 5/20; G06F 19/00

(52) U.S. Cl. 72/105; 76/107.4; 700/105

(57) ABSTRACT

The invention provides a method of designing shaping tools for metal containers (such as metal bottles) to minimize the formation of visible transition lines or ripples conventionally produced in such procedures as die necking and outward flaring. The method involves carefully measuring differences between an actual shape produced and a design shape resulting from an original set of shaping tools. The tools are then refined in design to take into account metal spring back and the effect of one shaping stage on the results of previous stages. The redesign goes through several iterations to ensure that each change produces an improvement of the formed container. In this way, the formation of transition lines can be minimized because the actual shape of the container more closely resembles the smooth design shape. Dies designed in this way are then used for commercial shaping operations.

### CROSS-REFERENCE TO RELATED APPLICATIONS

This application claims the priority right of prior copending U.S. provisional patent application Ser. No. 61/063,187 filed Feb. 1, 2008 by applicants herein.

### BACKGROUND OF THE INVENTION

I. Field of the Invention

This invention relates to the shaping of open ends of containers made of metal, especially the open ends of containers made of aluminum, steel or other metals of relatively high yield strength. More particularly, the invention relates to such shaping operations carried out with a series of shaping tools, such as necking dies or the like, to shape the containers progressively over a number of stages.

II. Background Art

Metal foodstuff containers, beverage cans, aerosol canisters, and other such containers for consumer or industrial products are often provided with inwardly- or outwardly-flared ends provided for esthetic reasons or for reasons of economy such as metal savings. For example, beverage cans are provided with an inward flare primarily to reduce the size of the metal end closure because the end closures are necessarily made of a thicker gauge metal than the container walls. Flared container ends of this kind are often produced by the process known as die necking whereby the open end of a container preform is forced into a succession of dies of ever decreasing (or increasing) diameter until the desired size reduction (or enlargement) of the tubular wall at the open end is achieved. A succession of small size changes is brought about in order to avoid metal buckling, ripping or tearing that generally occurs if large size changes are attempted.

While the die necking process is successful and is used on a large scale for the manufacture of beverage cans and the like, it has proven difficult or impossible to avoid the formation of visible circumferential transition lines or ripples in the necked-in portion of the resulting containers. One such transition line tends to be formed at each necking stage. In the case of conventional beverage cans, e.g. containers for beer or soft drinks, the problem is not especially acute because of the limited extent of inward necking and because of the necked area is a small portion of the can surface. However, there is a growing interest in producing metal containers that mimic glass bottles in shape and may thus have long flared shoulders or transition portions extending from the main body to a restricted opening at the neck. Such “metal bottles” have to be produced by a large number of die necking stages, for example 20 or more, which necessarily affect a large portion of the bottle surface. The result is that the circumferential transition lines tend to be highly noticeable in the finished Is product and detract considerably from its esthetic appearance. Furthermore, the lines may make it difficult for the product to accept writing, printing, labels or decoration without distortion or other undesirable visual effects.

U.S. Pat. No. 5,497,900 issued Mar. 12, 1996 to Caleffi et al., assigned to American National Can Company, discloses a die necking method purporting to produce a smooth tapered container wall and a reduced diameter neck. However, there is still need for improvement in order to obtain smoother transitions during such shaping operations.

### SUMMARY OF THE EXEMPLARY EMBODIMENTS

One exemplary embodiment of the present invention provides a method of producing a set of tools for use in a shaping operation to shape open ends of an identical set of tubular items made of a deformable metal of known physical properties in a plurality of shaping stages, which method comprises: establishing an optimal profile for the items as a preferred final design profile therefor; providing a first set of tools of progressively different operational size and shape that may be used in succession to shape the items to provide the items with an actual profile at the open ends thereof that approximates the design profile, the use of each tool representing a separate stage of the shaping operation; using the tools to shape one of the items in a multi-stage shaping operation to obtain, at each stage, the item having a first actual shaped profile; for each stage of the shaping operation, measuring a difference produced between the first actual shaped profile of the item and the predetermined design profile, the difference being caused by an amount of metal spring back and effects of prior shaping whereby one shaping stage modifies a profile obtained by a prior shaping stage; taking into account the known physical properties of the metal, the amount of metal spring and the prior shaping to redesign the operational size and shape of the tool intended for the stage of processing, to thereby obtain a second set of tools of first modified shape; repeating the steps of shaping, measuring and redesigning one or more times until the actual shaped profile substantially conforms to the design profile; and selecting a set of tools that caused the actual shaped profile to substantially conform to the design profile as the set of tools for use in the shaping operation, or as a model for producing one or more sets of tools of identical dimensions. It is to be noted that this process is iterative since changing the shape of a tool at one shaping stage may affect the shape already achieved in previous shaping stages. In the final shaping stage (reduction or expansion), the tool diameter at the land should preferably be adjusted to account for spring back.

Preferably, during the redesigning of the tools for each stage (except the first), a relief shape is incorporated into the shapes of the tools, the relief shapes being positioned in the tools and sized to have minimum impact on the shaping produced by previous stages. Optionally, the steps of shaping measuring and redesigning may be carried out virtually by means of a computer program (preferably employing finite element analysis).

According to another exemplary embodiment, a process is provided of shaping open ends of a set of identical containers made of the same metal, comprising first creating a set of shaping tools for the set of items, and then using the tools in a multi-stage tool forming operation to shape the open ends of the items. In this process, the set of dies is created by the method above.

The article that is shaped in the above manner is referred to herein as a container, but is generally a container body (as no lid or cap is fitted as yet) or a preform (an item that will eventually become a container or container body). Accordingly, the term “container” as used herein is intended to include all such articles. Additionally, the section of the container that is shaped, i.e. the transition between the main body portion and the neck (the end of the container at the opening), is usually referred to as the shoulder or transition section.

As noted, the containers are preferably made of aluminum or steel, but may be made of any metal that can be used to form foodstuff containers, beverage cans, aerosol canisters, and containers for other such consumer or industrial products. The container may be formed by various methods. One such method is the drawn-and-iron (D&I) method in which a flat metal sheet is subjected to one or more draw operations to form a cylindrical open-ended perform which may then be subjected to one or more ironing stages in which the side wall is thinned. As an alternative, the container may be created using a draw-redraw procedure, in which case the thickness of the side walls would not be much different from that of the starting sheet material itself. Taking both of these situations into account, the following metal thickness ranges (for aluminum) are particularly preferred for use in the invention: 0.002-0.080 inch (0.051-2.03 mm), and more preferably 0.005-0.025 inch (0.127-0.635 mm). A further alternative would involve impact extrusion in which a metal slug is compressed and extruded through a narrow annular gap to form the container side walls.

It has been found that if the actual curve of the shaped article follows the design curve to within ±0.0003 inches, transition lines are no longer of much concern in the finished products, even for metal bottles having long curved transition sections. To some extent, however, the resulting visual effect depends on the coatings applied to the container and on the surface reflectivity. To achieve this level of accuracy, the yield strength of the metal should preferably be known to within about 6%, and tool dimensional and positional accuracy should preferably be controlled to within about ±0.00025 inches.

The amount of spring back movement normally encountered and that can be adjusted by exemplary embodiments of the invention is generally 0 to 0.025 inch (0 to 0.63 mm), more preferably 0.0002 to 0.010 inch (0.0051 to 0.25 mm), and most preferably 0.0005 to 0.005 inch (0.013 to 0.13 mm).

The redesign of the shaping tools may be made relatively simple (in both the computer models and the actual physical tools). For example, the shaping surfaces below the land may be considered as three segments: an upper curve, a middle segment, and a lower relief curve. These are the segments that may be modified to improve the design. However, to achieve greater shape control, more detailed and accurate tool machining may be preferable.

### BRIEF DESCRIPTION OF THE DRAWINGS

FIG. 1 is a cross-section of a necking die and knockout punch typically used for die necking metal containers;

FIGS. 2A to 2D illustrate beginning phases of a shaping stroke employing tools of the kind shown in FIG. 1;

FIGS. 3A to 3D illustrate bottom phases of a shaping stroke employing tools of the kind shown in FIG. 1;

FIGS. 4A and 4B are superimposed profiles of original die shapes and modified die shapes;

FIG. 5 is a representation of a design curve and an actual curve of a shaped container as virtualized in a computer;

FIG. 6 is a graph showing an example of a curve showing deviations between actual shape and design shape;

FIG. 7 is a computer generated visualization of a container showing transition lines formed during shaping;

FIGS. 8 through 19 are graphs representing tool positions during necking stages 3 and 4;

FIG. 20 is a graph showing deviations of a container wall from a design profile produced by original tools and also a first set of modified tools;

FIG. 21 are superimposed profiles of an original die and a modified die;

FIG. 22 shows the profile of the modified die of FIG. 21 in isolation;

FIGS. 23 and 24 are graphs showing the effects of changes of the upper curve radius of a die on the lower sidewall without and with subtraction of the effects of an intermediate refinement;

FIGS. 25 through 35 are graphs showing stages of shaping using dies of modified design;

FIG. 36 is a computer generated visualization of a part of a container produced according to exemplary embodiments;

FIG. 37 is a graph showing the deviation in shape from a design shape for a container produced by an exemplary embodiment;

FIGS. 38 and 39 are graphs showing the effects of changes of yield strength of the metal (FIG. 38) and the friction between the metal container and tool (FIG. 39) on the match between actual shape and design shape; and

FIG. 40 is a cross-section of an example of an expansion die.

### DETAILED DESCRIPTION OF THE EXEMPLARY EMBODIMENTS

To illustrate the present invention, exemplary embodiments are described in the following disclosure. These exemplary embodiments relate to die necking operations used to shape a container at the open end and to provide the container with a deeply curved transition section resembling that of a glass wine bottle. It should be appreciated that shaping operations of other kinds, including outward flaring, may also employ techniques according to the present invention. Die necking procedures used for shaping operations are well known to persons skilled in the art and are described, for example, in U.S. Pat. No. 5,497,900 mentioned above (the disclosure of which is specifically incorporated herein by reference). The procedure involves a number of shaping stages to narrow the container neck in a progressive way. Each shaping stage involves the combined use of a necking die and a corresponding knockout punch. The knockout punch has to be changed or modified at each stage to accommodate a different land diameter as the container is shaped and progressively narrowed at the container entrance.

The shaping of the container neck is brought about by the use of a series of necking dies (typically made of tool steel, tungsten carbide, or ceramic) of progressively smaller inner diameter and shape. These tools are referred to as “shaping tools” to distinguish them from the knockout punches. An initial die is used to shape the container body in order to produce an inward bend or transition section most distant from the open end of the container. This defines the starting position of the transition section or shoulder. Then each successive die produces a bend progressively closer to the open end of the container, and closer to the center line of the container. In this way, the total reduction of diameter and profile of the shoulder are formed in small steps that can each be accommodated by the metal of the container wall without buckling or tearing.

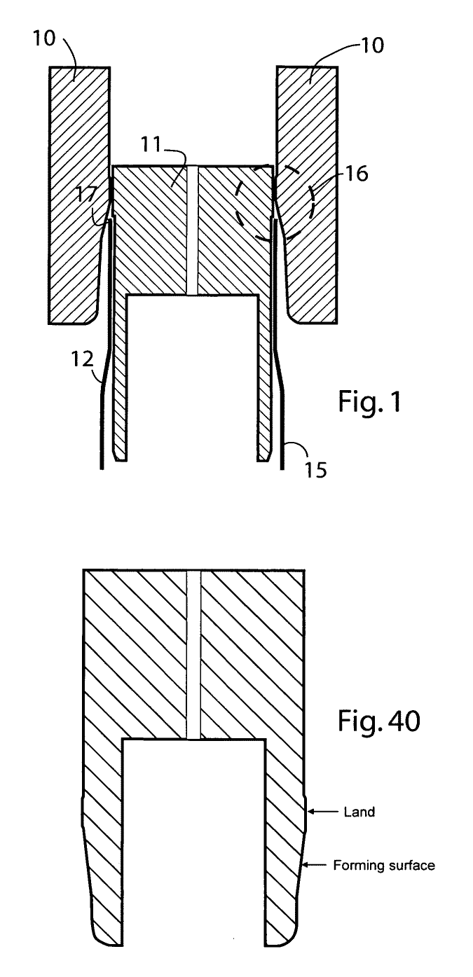

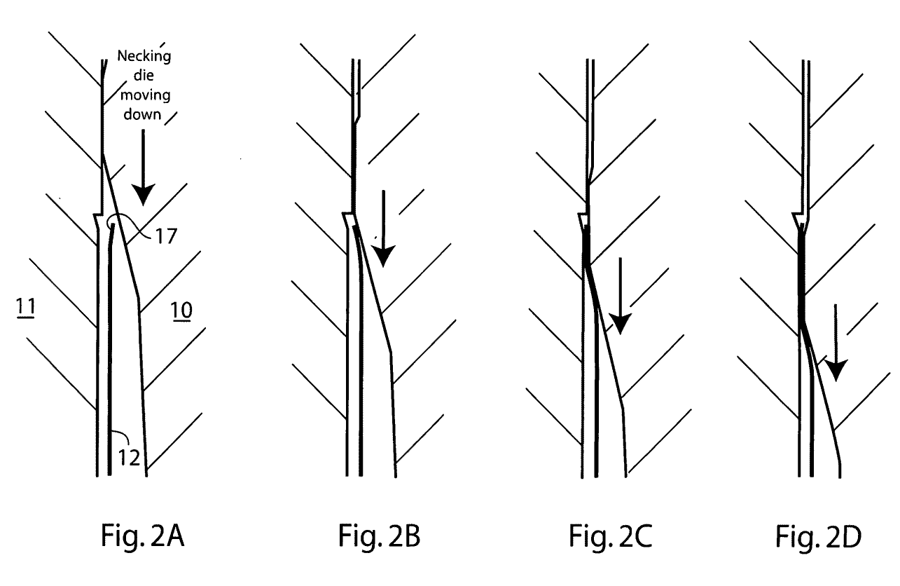

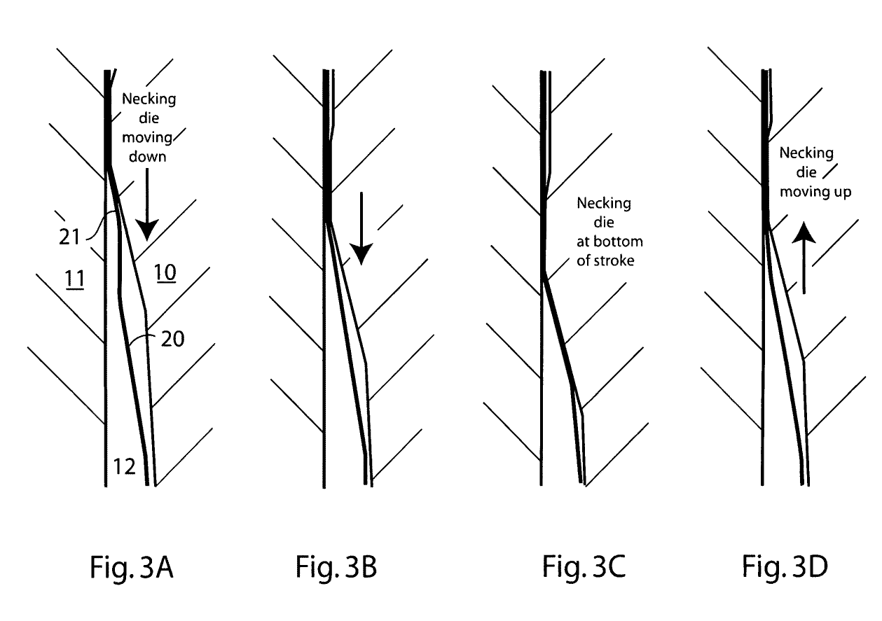

A typical combination of a shaping tool (necking die 10) and knockout punch 11 is shown in vertical cross-section in FIG. 1 of the accompanying drawings. The upper end wall 12 of a container 15 at the open end 17 is also shown in the drawing. The various parts are shown just prior to the start of a shaping stage, and the shape of the upper end of the container shows that this is not the first shaping stage but rather a later stage (e.g. the fourth). The part of the tools surrounded by a broken circular line 16 is represented on an enlarged scale in FIGS. 2A, 2B, 2C and 2D, and also in FIGS. 3A, 3B, 3C and 3D. These figures represent a die specifically designed for the shaping stage, but not yet modified according to procedures outlined below, and the figures illustrate various phases during the shaping stage. FIGS. 2A to 2D show the beginning phases of the shaping stroke and FIGS. 3A to 3D show the bottom phases of the shaping stroke. In FIGS. 2A to 2D, the container wall at the open end is gradually squeezed inwardly from the open end 17 down. Towards the bottom of the stroke as shown in FIGS. 3A, the shaping effect approaches an outward curve 20 produced in previous shaping steps. The outward curve 20 starts to merge with the newly-forming curve 21 as shown in FIG. 3B and eventually meets the die wall as shown in FIG. 3C. FIG. 3D shows the die moving up relative to the container wall at the end of the shaping stage.

The inventor of the present invention has noticed that, during such shaping of metal bottles and other containers, both elastic and plastic deformation occur. Plastic deformation is necessary to achieve the desired shaping of the item. Elastic deformation is not permanent and results in a small shape change when the item is released from the die due to the tendency of the metal to spring back towards its original shape when the pressure or force exerted by the tooling is removed. It is believed that this metal spring back may contribute to the formation of transition lines, as does the use of tooling having curves with radii that bend the metal too sharply. It has also been observed that the shaping achieved during one stage of the operation may adversely affect the shape already produced during an earlier stage, i.e. later shaping stages can adversely affect the results of earlier shaping stages, again contributing to an undesired rippling effect in the product.

In exemplary embodiments of the present invention, metal spring back is taken into account by appropriately modifying the shapes and dimensions of the dies relative to their accepted conventional shapes used for producing a particular design of metal bottle. Basically, the container is formed at each stage to an extent larger than conventionally done so that the metal springs back to a position closer to the intended shape (the so-called design shape of the product). Furthermore, the tool is preferably shaped to minimize undesirable effects on the shapes produced by previous stages of the shaping process. This modification of the tool shapes is carried out according to an iterative process to produce a set of shaping dies that minimize or avoid rippling in the finished product.

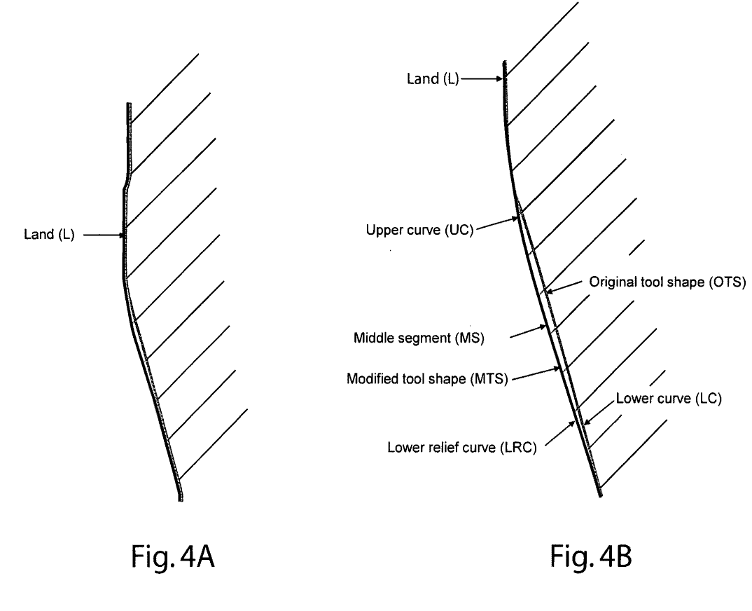

FIGS. 4A and 4B illustrate the shape of a conventional necking die of the kind shown in FIG. 1 and the shape of a die modified according to an exemplary embodiment of the invention. FIG. 4A is an overall view, whereas FIG. 4B is a magnified view of a part of the surfaces below the land consisting of an upper curve, a middle segment and a lower curve as shown. The outlines of the two tools are superimposed and thus differ only in those parts showing two lines. In FIG. 4B, the original tool profile is shown on the right, and the tool modified according to an exemplary embodiment is shown on the left (as marked). The modified tool will bend the container wall more deeply (inwardly) than the original tool, thus allowing metal spring back to return the container wall to a position more closely aligned with the design shape. The modified tool also has a lower relief curve as shown.

This process by which the modified tool is designed is illustrated in the following.

Firstly, a complete die necking operation may be carried out with an original (conventional) tool set and the product inspected and carefully measured to establish differences between the design shape and the actual shape of the article. The differences are normally the result of metal spring back, and the neck of the container tends to be of larger diameter than would have been expected from the shapes of the dies. Optionally, an initial adjustment from the conventional dies is then carried out by modifying all of the dies used to form the necked container or a particular section thereof. The modification of the dies represents a first attempt to compensate for metal spring back, and the dies are generally modified to bend the metal at each stage to a greater extent than would normally have been expected to form the design shape, thus allowing the metal to spring back to a position closer in shape and position to the design shape. A complete die necking operation may then be carried out using the dies modified in this way, and the resulting product is again observed and carefully measured. Then, a die for a single stage may be modified in order to test the effects of that modification while keeping the other dies the same. In this way, one die at a time would be modified while each time carrying out an entire die necking operation and keeping the other dies unchanged. In this way, the effect of the modification of a single tool can be measured and used to define a new tool shape in order to achieve a shape change that brings the actual shape of the product closer to the design shape. This is repeated for each tool employed for the entire die necking operation or a defined section thereof. Then, after using this modified set of new tools for a complete die necking operation, the deviation from the intended design shape would be measured, and further modifications made to minimize the observed deviation even further. In theory, there may be as many such iterations as are required to produce an actual shape that corresponds perfectly to the design shape, but in practice there is a trade off between the number of iterations and the effective improvement actually observed. In general, significant improvement is no longer achieved after approximately four iterations, although the actual number depends on many factors, such as the design shape, the metal of the container and the thickness of the container wall, the work hardening of the metal, etc. In general, however, there are at least two such iterations, and preferably two to eight.

As well as modifying the designs to compensate for spring back, the dies are preferably also modified in such a way that a die used in a subsequent shaping step modifies the shape obtained in a previous shaping step only to a minimum extent, if at all. This is normally achieved by providing the second and subsequent dies with a profile “relief” in the interior of the die so that contact with metal previously shaped is modified as its dimensions vary transiently under the pressures exerted by the shaping stage currently in operation. The relief designed into the shape of the die does not completely avoid metal shaped in the previous stage. For example, if a narrowing shoulder is being formed at the top of a container, at each shaping stage a small segment of the container wall is moved inward by the surface of the shaping tool to partially form the shoulder. The container wall must slide over the surface of the shaping tool. Therefore the shaping surface should preferably have a gradual entrance slope or curve at the bottom where the container wall is guided into the tool. There should also be a gradual exit curve at the top of the shaping surface to define the transition from the shaping surface to the land.

A conventional shaping surface can be regarded as consisting of three segments below the land, an upper exit curve, a middle forming segment, and a lower entrance segment. Each of these segments has an unavoidable effect on shaping the container wall. In a conventional necking die, the lower entrance segment is usually conical and tangential to the middle forming segment. The inventor of the present invention noticed that the shape of this segment can have a significant effect on the shape of the metal formed in the previous stage, i.e. it can bend the metal too far, in which case it springs back to a shape with an indentation, or it can bend the metal not far enough, in which case there will be a protrusion. In the exemplary embodiments, the lower entrance segment is preferably provided with a relief curve which is designed to contact and form the upper region of the container wall that was formed in the previous stage in such a way that it accounts for spring back to produce a final shape that conforms to the design shape. The tool surface does contact the previous stage, but the influence of that contact is measured and controlled.

Also, the method of the exemplary embodiments will show if tooling radii are too small, i.e. if sharp bends are produced which are difficult to correct in later stages. For example, if a new bend produced by one stage (e.g. stage 3) persists after forming in the next stage (e.g. stage 4) is complete, this suggests that the tool radius (this is, the upper curve radius) in stage 3 is too small, i.e. the metal was bent too much and this sharp bend cannot be removed by later stages. The stage 3 die shape should then be modified to increase the tool radius.

After the procedure has been completed, sets of dies having the resulting shapes and dimensions may be prepared and used for commercial die necking operations to produced necked containers that have smooth curves virtually free of highly visible transition lines. The set of dies is normally effective only for containers of substantially the same physical properties as those for which the iterative design process was carried out, but sets of modified dies can be created for all well-known types of containers (e.g. those having differences of wall thickness, metal specification, container dimensions, and the like).

The iterative process of the exemplary embodiments is preferably simulated within a computer (i.e. virtually), rather than being carried out in reality, by means of a suitable program, preferably one employing finite element analysis (FEA). This is a computer simulation technique that can be used in engineering analysis. Basically, in this procedure, a finite element mesh is generated. This is a construct within a mathematical modeling program comprising a connected group of elements which defines a shape. Each element has material properties associated with it, responds to contact, friction, forces and other boundary conditions, and is able to deform under the influence of these boundary conditions while following the rules imposed by its assigned material properties and connectivity with other elements. An finite element mesh can therefore represent a physical object, and can be formed (within the finite element software) just like a physical object can. Computer programs employing finite element analysis are well known and commercially available. Examples include a program called ABAQUS® from SIMULIA® of Rising Sun Mills, 166 Valley Street, Providence, R.I. 02909-2499, U.S.A., as well as LS-DYNA® from Livermore Software Technology Corp. of Livermore, Calif., U.S.A., and ANSYS Mechanical®, from ANSYS Inc. of 2855 Telegraph Avenue, Suite 501, Berkeley, Calif. 94705, U.S.A.

The effectiveness of the FEA process depends on an accurate knowledge of the material properties of the container, especially the elastic modulus, yield strength and work hardening rate. These properties can be obtained by standard materials testing methods on representative metal or container wall samples, and are used as inputs for the computer program.

Once the FEA process has arrived at a set of die shapes of optimized design, the tools are made and are used for commercial die necking of the containers. Of course, the dies should be produced with actual designs made as faithfully as possible to those dictated by the FEA process.

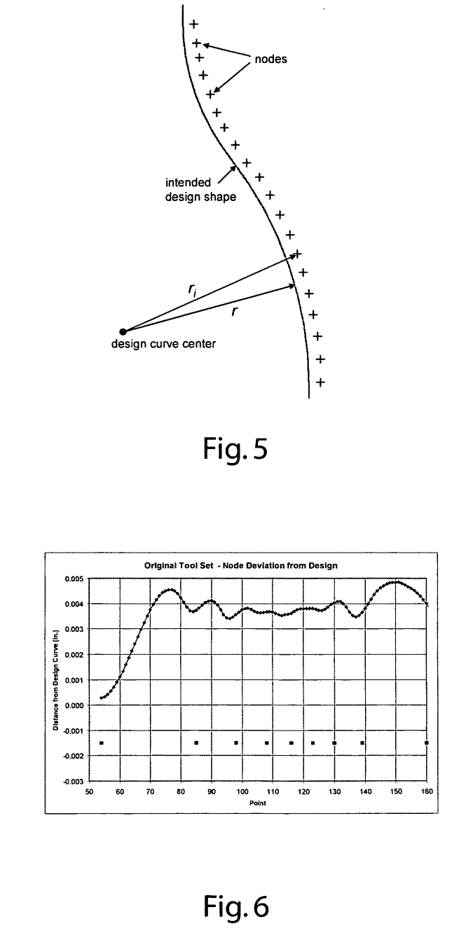

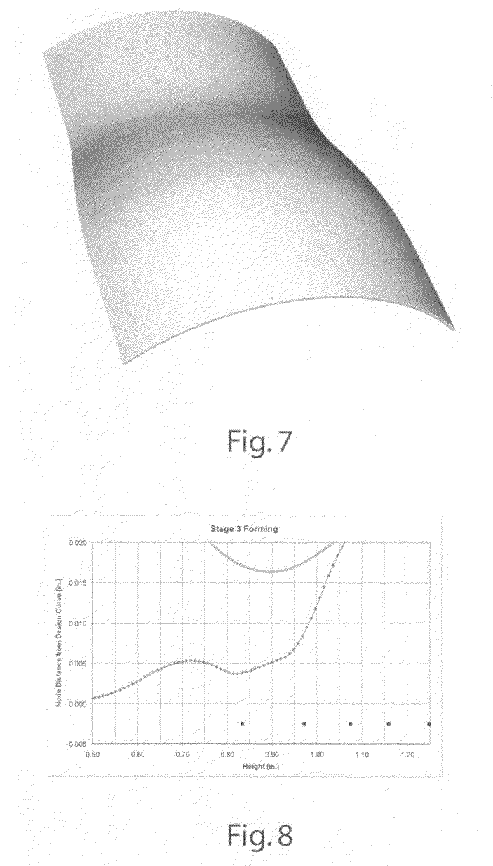

The virtual procedure is exemplified by the following. By means of computer program, a finite element mesh is used to represent a container or the relevant part thereof. The container is die necked virtually using FEA in successive stages with an initial tool set. The resulting shape is compared to the intended design curve, an exaggerated example of which is shown in FIG. 5 of the accompanying drawings. This shows deep necking stages of a metal container to provide it with the shape of a glass bottle (actually, just one side of the neck of the container is shown). This simulates the formation of a metal bottle using industry standard tool designs. FIG. 5 shows the intended shape of the container wall as the solid line and the actual shape represented by a series of crosses placed at various nodes. The container is designed to have a radius “r” (the design shape) but in fact has a radius “rᵢ” as shown. The difference from the design shape at each node “i” is “rᵢ−r”. The values of rᵢ−r at each node may be plotted on a graph to clearly show the deviation of the shape from the design curve. An example of a curve of this kind is shown in FIG. 6 where points 50 to 160 on the X axis represent nodes on the outer bottle surface in the neck region, stages 1 through 8. The graph shows how much the shape deviates from the design shape after 8 stages of die necking using tooling of conventional design. The ripples on this curve show up as visible transition lines on a reflective surface of the actual product. The upper limit of the region of contact for each stage is shown. FIG. 7 is a computer-generated visualization of the appearance of the neck of the resulting container. The undesired transition lines or ripples are visible.

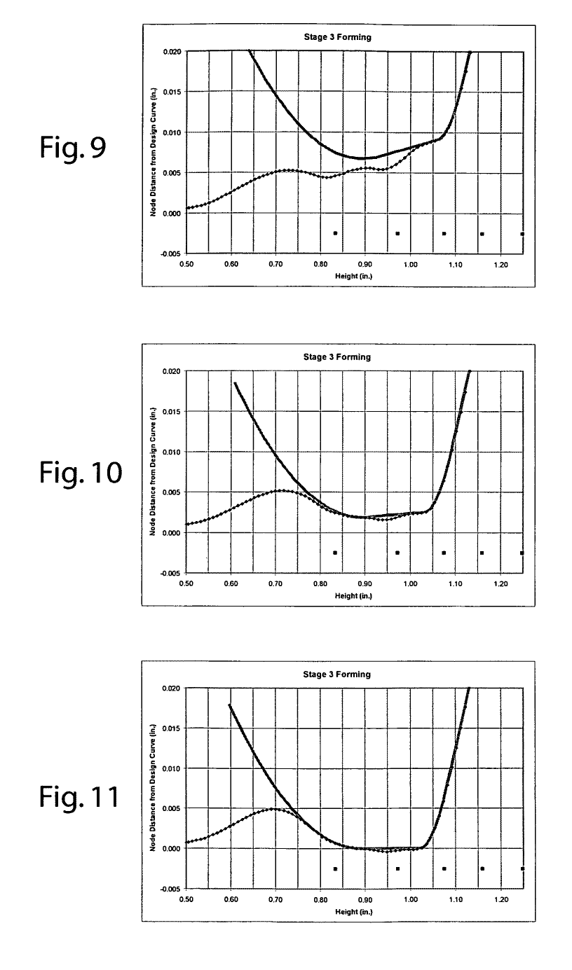

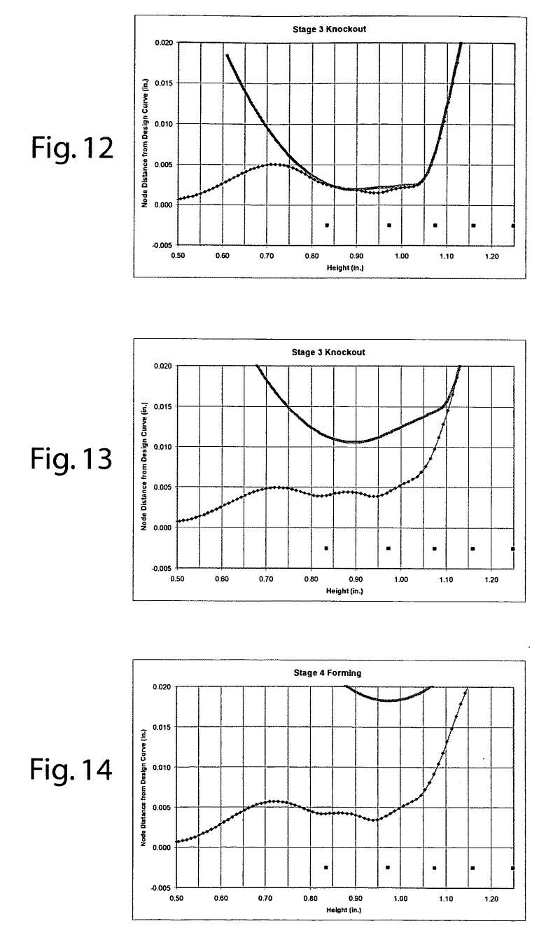

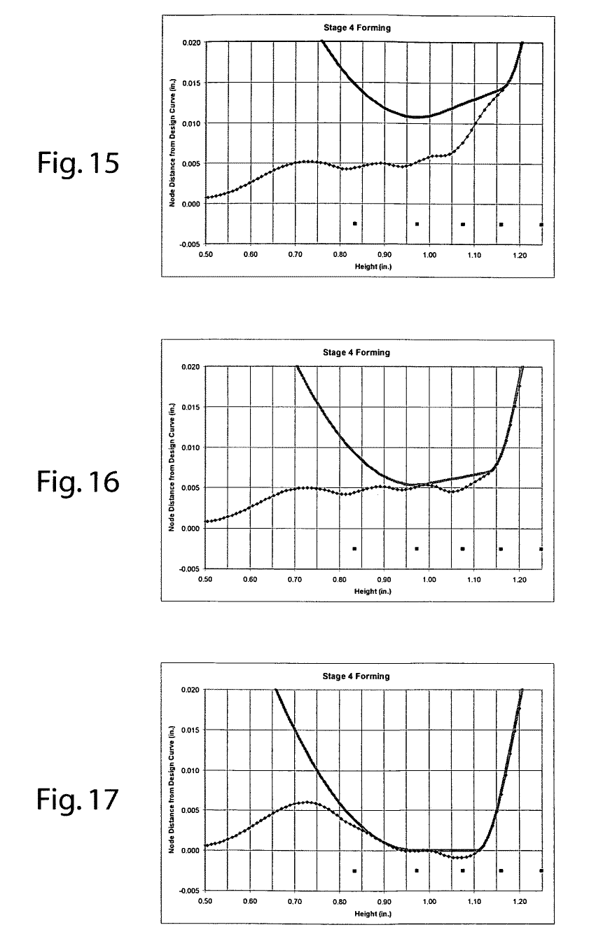

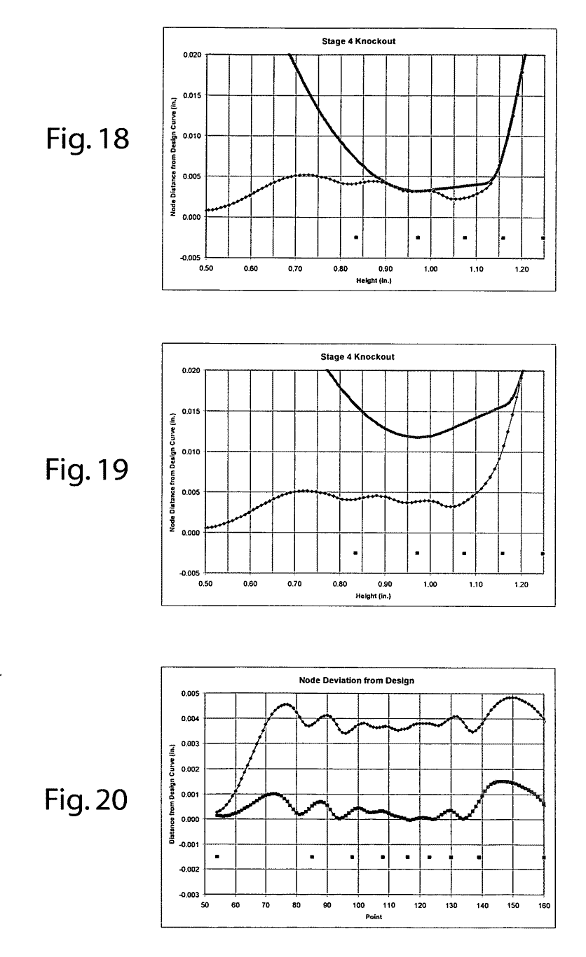

FIGS. 8 to 19 are curves showing selected tool positions from necking stages 3 and 4 using conventional tooling. These curves show how the tool shape and motion ultimately produce transition lines. The container surface in each drawing is represented by the line incorporating diamond-shaped dots (lower line), the dots being nodes in the finite element mesh. The tool surface is represented by the smooth solid line (upper line). This line changes shape as the tool moves in the radial coordinate system. FIG. 8 shows the state of the container surface at the end of the second forming stage. The bends produced by the first two stages are visible. FIG. 11 shows how the conventional tool of the third stage contacts regions of the container neck already formed and re-shapes those regions. FIG. 13 shows the state at the end of the third stage and indicates the spring back that occurs, as well as the new bend produced by the third stage. In the fourth stage, contact with bends from previous stages is again shown in FIG. 17, and FIG. 19 shows the spring back that occurs and the bend left over from stage 3. Clearly, the result is a rippled surface that deviates from the intended curve design.

Based on these graphs, tool positions and dimensions are adjusted using an initial estimate to bring the curve closer to the intended shape. This is represented in FIG. 20 where the upper curve shows the deviation of the container wall from the design curve produced by the conventional shaping tools, and the lower curve shows the deviation when using the first set of re-designed tools. This shows that the actual curve is closer to the design curve for the re-designed tools. This process is repeated with further refinements to the tooling until the objective of appearance and shape are met.

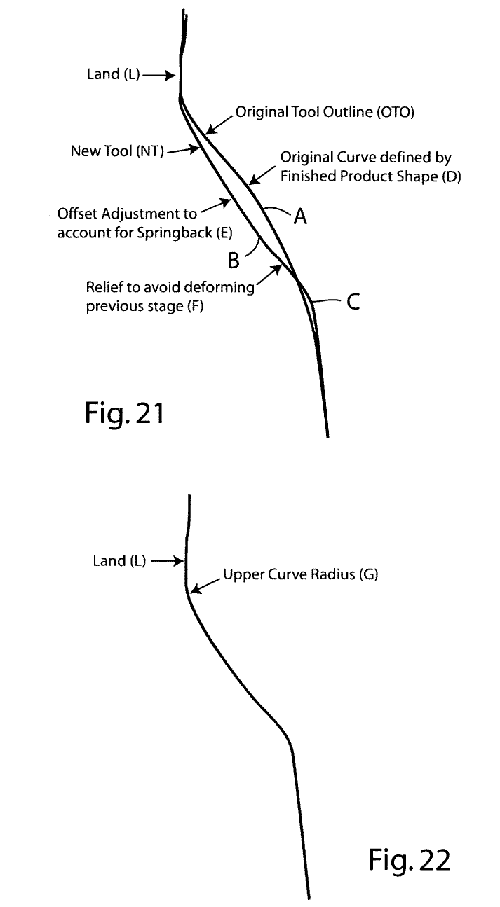

FIG. 21 is a diagram similar to FIG. 4B showing the kind of change made to the shaping tool after the first, or a subsequent, shaping operation. Line A represents the outline of the original tool corresponding to the finished shape of the container wall, and line B illustrates the outline of the re-designed tool. The re-designed tool includes an offset C to account for spring back and a relief to avoid deforming the shaping achieved in previous stages. The upper end of the curves represents the tool lands. FIG. 22 shows the outline or profile of the redesigned tool of FIG. 21 in isolation.

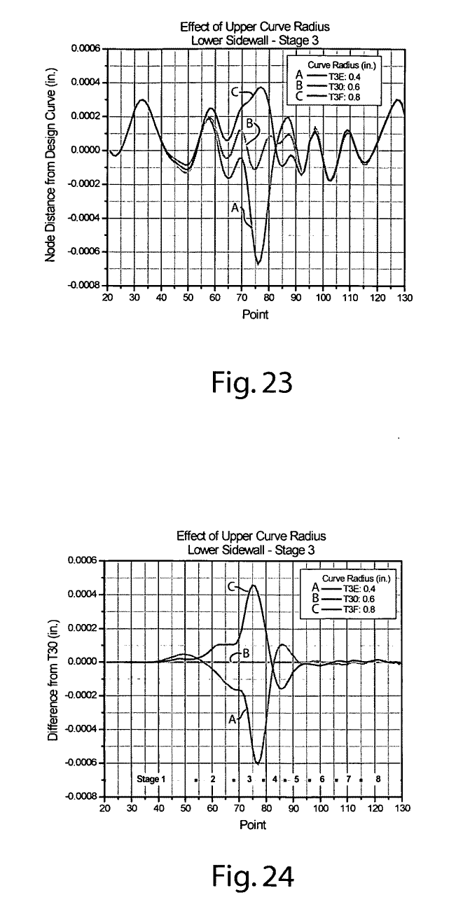

After the initial redesign of the tool shape, small changes are made to individual tool dimensions and the effects are noted. For example, the upper curve radius as shown in FIG. 22 is changed by certain amounts and these have the effects shown in FIG. 23. Curve B shows the effects of an intermediate refinement of the conventional tools (having an upper curve radius of 0.6 inches), and curves A and C are based on the intermediate refinement, but with different upper curve radii (0.4 and 0.8 inches, respectively).

To isolate the effect of changing the upper curve radius, the result produced when the radius is 0.6 inches can be subtracted to give a graph as shown in FIG. 24. In this Figure, the curve designations are the same as those in FIG. 23 (Curve B being a flat line). In this way, a known effect of a given tool change can be determined, and such information can be used to refine the shape further. The same principle can be applied to other tooling changes and their effects determined. It should be noted, however, that regions beyond the stage under consideration may also be affected. For this reason, an iterative process is necessary.

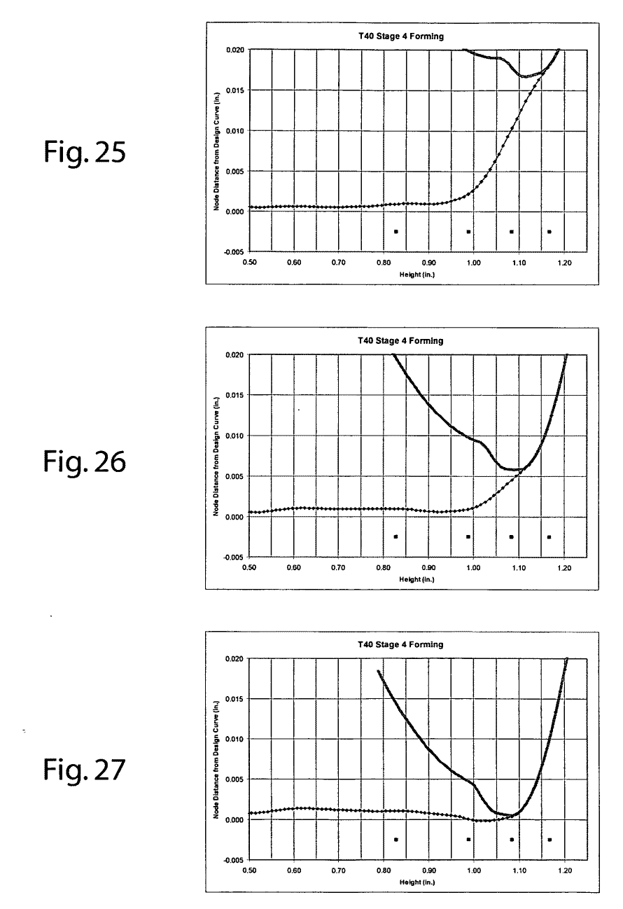

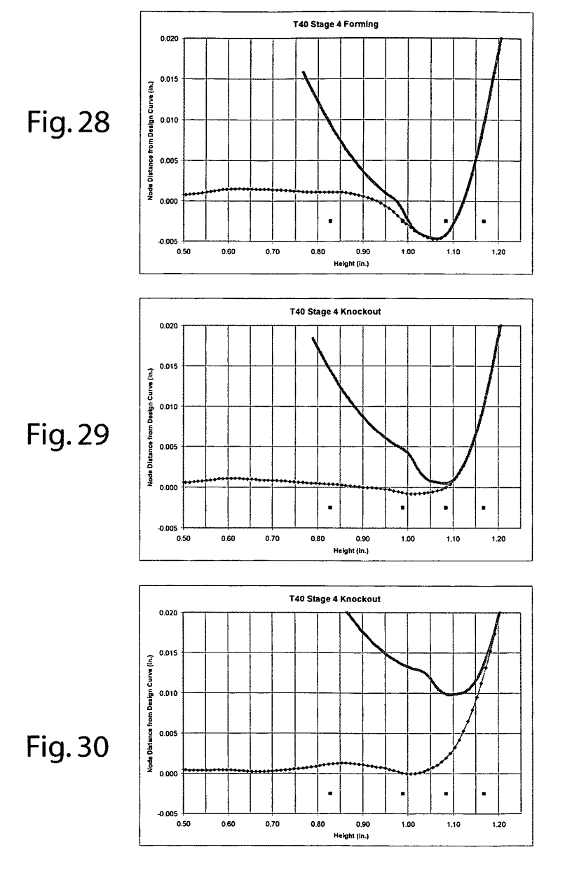

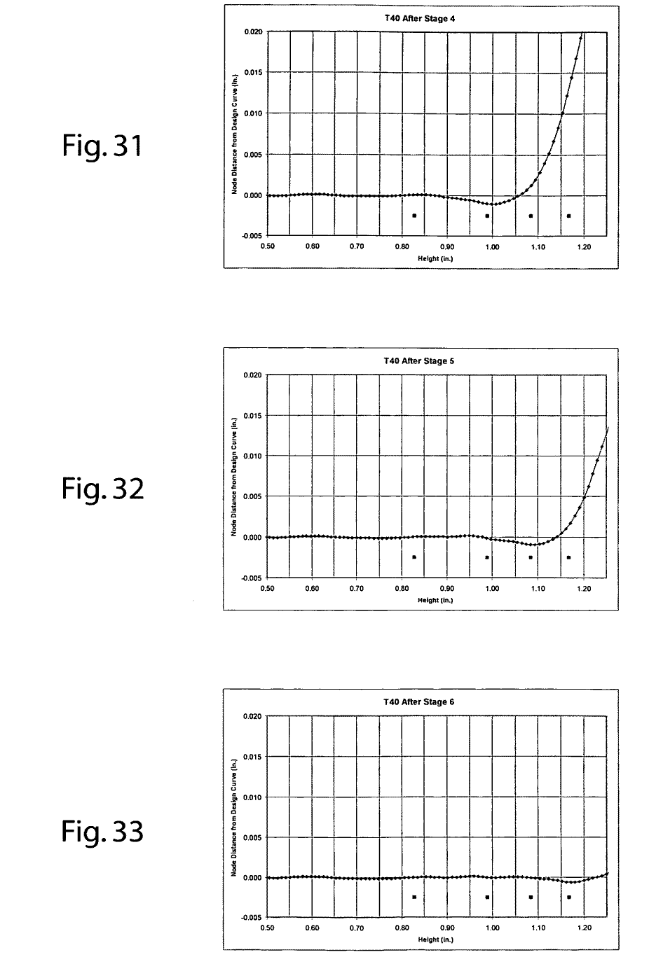

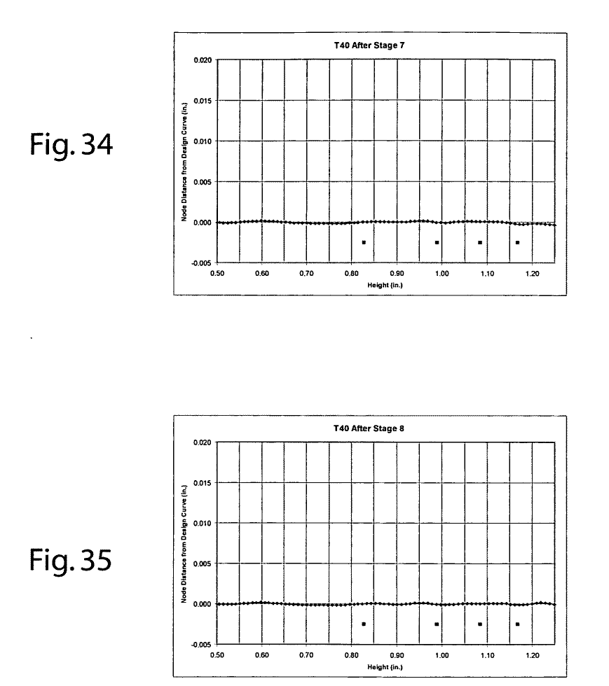

FIGS. 25 to 35 show how the shape of the container can be precisely controlled by modifying the tooling shape and motion. The figures show selected tool positions for stage 4 with modified tools. The modifications are the result of the iterative process described previously. In this example, stages 1 to 3 have already been formed with tooling modified to bring the final shape close to the design shape, i.e. close to the zero line on the graph. The relief in the tooling can be seen, which avoids deforming areas that have already been formed. The figures also show how the tool is moved beyond the design shape (below the zero line) to allow the metal to spring back to the correct shape (see FIG. 28). As can be seen, the shape following stage 4 (FIG. 31) retains only a small depression below the zero line. A comparison of FIGS. 11 and 28 shows the reduced effect of the die on the shapes produced in previous stages for the modified dies.

By using similarly modified tooling in subsequent stages, the container shape is brought ever more closely into correspondence with the design shape. Stage 5 retains a small depression (FIG. 32) like that of stage 4, but stages 6, 7 and 8 (FIGS. 33, 34 and 35, respectively) produce a curve that is almost exactly in line with the design shape due to appropriate allowance for springback and the effect that one stage has on previous stages.

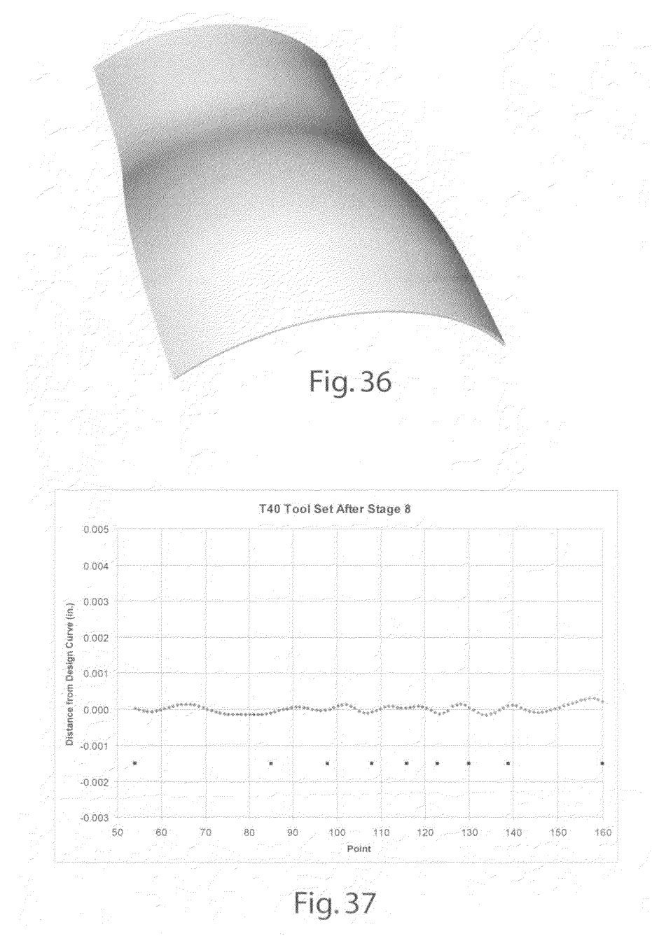

FIG. 36 is a representation of a part of a container wall produced by using tooling modified in the above manner (compare this with FIG. 7). Transition lines are much reduced or have been eliminated. The deviation of the shape of this container from the design curve is shown in FIG. 37 for each of eight stages of shaping. The line is not a perfect match, but it is very close, within ±0.0003 inches of the intended shape, and any minor ripples are hard to see in the finished product.

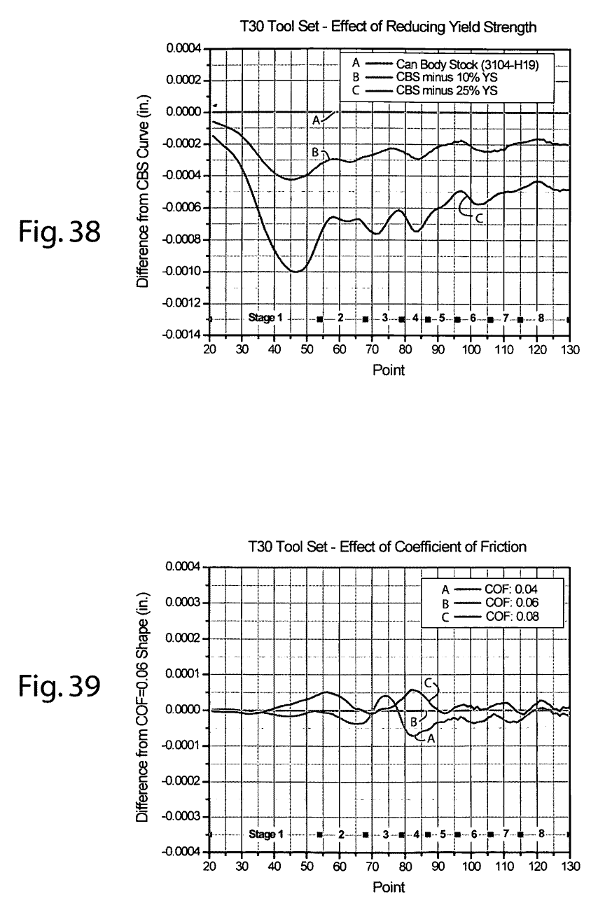

The same kind of analysis can be used to investigate the effects of other changes, e.g. a change in the yield strength of the metal, or the coefficient of friction between the container wall and the shaping die. For example, FIG. 38 shows the effect of variations in the yield strength of the metal of the container. Line A represents conventional can body stock (AA3104-H19), and lines B and C represent a 10% reduction in yield strength and a 25% reduction in yield strength, respectively. The curves show that the 10% reduction has less of a negative impact than the 25% reduction. It is therefore important to maintain the design yield strength of the containers to be shaped so that there will be little variation.

FIG. 39 shows the effects of differences of coefficients of friction between the tool surface and the metal being formed. Three different values for the coefficient of friction, which are intended to cover the approximate range that might be encountered in the die necking process, are used for a tool set that produces a final shape which is close to the intended shape. The curves on the graph show the difference in deviation from the intended shape where the coefficient is 0.06, that is, each result is subtracted from the result obtained where the coefficient is 0.06. Curve A shows the difference for a coefficient of friction of 0.04. Curve B becomes zero at all points for a coefficient of friction of 0.06. Curve C shows the difference for a coefficient of friction of 0.08. The figure shows that there is little variation (much less than 0.0003 inches) among these results, so variations of coefficients friction apparently do not have great consequences and standardization of this among the containers to be shaped is of lesser importance.

The exemplary embodiments described above are based on die necking reduction of the first eight necking stages of a bottle forming process, but the same steps may be used for expansion, as well as to other container shapes. FIG. 40 is a cross-section of an example of an expansion die positioned on the same sheet of drawings as FIG. 1 illustrating a reduction die so that similarities and differences can readily be seen. It is believed that a person skilled in the art could apply the procedures of the exemplary embodiments relating to reduction dies readily to expansion dies of the kind shown in FIG. 40.

1. A method of producing a set of tools for use in a shaping operation to shape open ends of an identical set of open-ended containers made of a deformable metal of known physical properties in a plurality of shaping stages, which method comprises:
establishing an optimal profile for the containers as an intended final design profile therefor;
providing a first set of shaping tools of progressively different operational size and shape that may be used in succession to shape the containers to provide the containers with an actual profile at the open ends thereof that approximates the design profile, the use of each shaping tool representing a separate stage of the shaping operation;
using the tools to shape containers in a multi-stage shaping operation to obtain containers having a first actual shaped profile;
for each stage of the shaping operation, measuring a difference produced between the first actual shaped profile of the container and the predetermined design profile, the difference being caused at least in part by an amount of metal spring back and effects of prior shaping whereby one shaping stage modifies a profile obtained by a prior shaping stage;
taking into account the known physical properties of the metal, the amount of metal spring and the prior shaping to redesign the operational size and shape of the tool intended for the stage of processing, to thereby obtain a second set of tools of first modified shape;
repeating the steps of shaping, measuring and redesigning one or more times until the actual shaped profile substantially conforms to the design profile; and
selecting a set of tools that caused the actual shaped profile to substantially conform to the design profile as the set of tools for use in the shaping operation, or as a model for producing one or more sets of tools of identical dimensions.

2. The method of claim 1 wherein, during the redesigning of the tools for each stage except a first thereof, a relief shape is incorporated into the shapes of the tools, the relief shapes being positioned in the tools and sized to avoid the prior shaping.

3. The method of claim 1, wherein the steps of shaping measuring and redesigning are carried out virtually according to a computer program.

4. The method of claim 3, wherein the computer program employs steps of finite element analysis.

5. A process of shaping open ends of a set of identical open-ended containers made of the same metal, comprising first creating a set of shaping tools for the set of containers, and then using the tools in a multi-stage tool forming operation to shape the open ends of the containers, wherein set of shaping tools is created by:
establishing an optimal profile for the containers as a preferred final design profile therefor;
providing a first set of tools of progressively different operational size and shape that may be used in succession to shape the containers to provide the containers with an actual profile at the open ends thereof that approximates the design profile, the use of each shaping tool representing a separate stage of the shaping operation;
using the tools to shape one of the containers in a multi-stage shaping operation to obtain, at each stage, the container having a first actual shaped profile;
for each stage of the shaping operation, measuring a difference produced between the first actual shaped profile of the container and the predetermined design profile, the difference being caused by an amount of metal spring back and effects of prior shaping whereby one shaping stage modifies a profile obtained by a prior shaping stage;
taking into account the known physical properties of the metal, the amount of metal spring and the prior shaping to redesign the operational size and shape of the tool intended for the stage of processing, to thereby obtain a second set of tools of first modified shape;
repeating the steps of shaping, measuring and redesigning one or more times until the actual shaped profile substantially conforms to the design profile; and
selecting a set of tools that caused the actual shaped profile to substantially conform to the design profile as the set of tools for use in the shaping operation, or as a model for producing one or more sets of tools of identical dimension.

6. A method of designing a set of tools for use in a shaping operation to shape open ends of open-ended containers made of a deformable metal in a plurality of shaping stages, which method comprises:
establishing a design profile for the containers, said profile including a smooth transition section;
providing a first set of shaping tools of progressively different operational size and shape adapted for use in succession to shape the containers to provide the containers with an actual profile adjacent the open ends thereof that approximates the design profile, the use of each shaping tool representing a separate stage of the shaping operation;
using the tools to shape a container in a multi-stage shaping operation to provide said container with a first actual shaped profile at each stage;
for each stage of the shaping operation, measuring a difference between the first actual shaped profile of the container and the design profile;
modifying said operational size or shape of each tool to cause said tool to produce an actual profile closer to said design profile;
carrying out shaping operations on said containers, each time using a different one of said modified tools without changing other tools and measuring differences between actual profiles and said design profile for each stage;
further modifying said operational size or shape of said tools to cause said tools to produce actual shaped profiles of said containers at each stage that are still closers to said design profile, and carrying out further shaping operations on said containers using a different one of said further modified tools each time while keeping the other tools the same, and again measuring differences between actual profiles thereby produced at each stage and said design profile;
if necessary, repeating the steps of further modifying said operational size or shape of said tools to cause said tools to produce actual shaped profiles at each stage that are still closer to the design profile, using said tools in shaping operations, measuring actual profiles thereby produced at each stage and comparing said actual profiles with said design profile, said steps being repeated until an actual profile produced by said tools at each stage differs from said design profile by a predetermined amount, said tools then being considered to be of final design.

7. The method of claim 6, wherein said first set of shaping tools is itself derived from an earlier set by carrying out a shaping operation on a container and measuring differences between an actual profile produced at each stage and said design profile, and then modifying an operational size and shape of all of the tools based on said differences without carrying out further shaping of the containers.

8. The method of claim 6, wherein, during the modification of the tools for each stage except a first thereof, a relief shape is incorporated into the shapes of the tools, the relief shapes being positioned in the tools and sized to avoid undesired modification of an actual profile resulting from an earlier stage.

9. The method of claim 6, wherein the steps of shaping measuring and modifying are carried out virtually by computer numerical control.

10. The method of claim 9, wherein the computer numerical control includes finite element analysis.

11. The method of claim 10, wherein said finite element analysis relies on calculations employing values of yield strength of the metal.

12. The method of claim 6, wherein the metal container walls exhibit plastic deformation and elastic deformation when shaped, and wherein said tools are modified to minimize effects of the elastic deformation that cause an actual profile produced by a shaping tool to differ from said design profile.

13. The method of claim 6, applied to containers made from a metal selected from alloys of aluminum and steel.

14. The method of claim 6, wherein said predetermined amount is ±0.0003 inch.

15. A method of producing a set of tools for use in a shaping operation to shape open ends of open-ended containers made of a deformable metal in a plurality of shaping stages, which method comprises designing a set of tools of said final design according to the method of claim 6, and then producing tools according to said final design.

16. A process of shaping open ends of a set of open-ended containers made of the same metal, comprising first creating a set of shaping tools for the set of containers, and then using the tools in a multi-stage tool forming operation to shape the open ends of the containers, wherein set of shaping tools is created by the method of claim 15.
